(19) United States
(12) Patent Application Publication
(10) Pub. No.: US 2002/0020455 A1
(43) Pub. Date: Feb. 21, 2002

(54) Pressurized fluid pipe

(76) Inventors: Paolo Balbi, Genova (IT); Pierluigi Picco, Genova (IT)

Correspondence Address: JENNER & BLOCK, ONE IBM PLAZA, CHICAGO, IL, 60611, US

(21) Appl. No.: 09/918,051

(22) Filed: Jul. 30, 2001

(30) Foreign Application Priority Data
Dec. 1, 1999 (IT) SV 99A 000 038
Nov. 28, 2000 (GB) PCT/GB00/04535

(51) Int. Cl. F16L 9/14

(52) U.S. Cl. 138/143; 138/146

(57) ABSTRACT

A pipe for pressurized-fluid feed systems, such as a diesel engine fuel pipe, has a wall of predetermined thickness with an internal surface and an external surface and an internal bore with a predetermined diameter for through-flow of the fluid. The internal surface and/or external surface are subjected to a nitriding or carbonitriding treatment, so as to obtain an increase in the hardness and/or the mechanical strength of the pipe, with regard to both stresses due to the pressure of the fluid and axial stresses due to flexing of the pipe.

### BACKGROUND OF THE INVENTION

1. Field of the Invention

The invention relates to a pipe for pressurised-fluid feed systems, in particular for feeding fuel in diesel engines or the like, comprising a wall of predetermined thickness with an internal surface and an external surface and an internal bore with a predetermined diameter for through-flow of the fluid.

2. Description of the Related Art

As is known, the evolution of diesel engine technology, and in particular the transition from a feed system with a precombustion chamber to a direct-injection feed system, has resulted in a considerable increase in engine performance. However, some undesirable effects have been noted. Direct feeding, for example, results in a considerable increase in the pressure with which the fuel is fed to the injectors. The injectors are each fed by a duct or pipe which is subject to the high internal pressure of the fuel and which must therefore have hardness and mechanical strength characteristics such as to be able to withstand high radial and tangential stresses. Moreover, the abovementioned increase in performance has resulted in a considerable increase in the vibration affecting all the parts of the engine and in particular the abovementioned fuel feed ducts or pipes.

Vibrations cause alternating flexing of the pipe, which is characterized by the material stressing in the axial direction of the said pipe or pipe wall. These vibrations, together with the effect of the internal pulsating pressure, may cause cracks or fractures in the pipe, with the leakage of fuel, or even complete breakage of the pipe. It should be noted, moreover, that generally said pipes are produced by means of drawing and that, for this reason, the internal wall may have microscopic cracks or flaws due to the machining process. The high pressure of the fluid, together with the vibrations, may cause a worsening of said microscopic cracks which may reach the external wall with all the said undesirable effects described above.

In addition, problems may arise with regard to the seal in the zone for joining each duct or pipe to the associated attachment points. On the injector side, as is known, the pressure of the fuel reaches maximum values. In fact, the increase in the feed pressure has resulted in the need for the strengthening of the material from which the injectors are made. The difference in hardness between said material, which generally consists of hard or hardened metal, and that of the pipes, which are generally made of less hard metal, may result in the leakage of fuel in the contact zone between pipe and injector, due to the effect of the vibrations.

Similarly leakages may also occur in the pipe/pump connection zone even in the presence of lower pressures.

All of the abovementioned problems may also occur in so-called “common rail” feed systems which, as is known, envisage a distribution or manifold element from where the fuel feed pipes depart towards the injectors. The manifold consists of a tubular element which is also subject to the stressing action of the internal pulsating pressure and the vibrations.

Various solutions have been proposed in order to overcome the abovementioned drawbacks. Generally, treatments and/or external linings of various types, in particular of the metallic type, are used in order to obtain an increase in the mechanical strength of the pipes. These linings, however, may have various drawbacks:

difficulty in applying them uniformly to the internal wall of the pipe owing to the small diameter of the bore;

difficulty associated with the fact that if the treatment is performed before machining of the end of the pipe which generally involves a widening in the cross-section of the said pipe with a shape, for example in the form of an ogive, ie a diagonal rib, the benefit of this treatment is lost due to the machining of the end. Moreover, the application of any lining material in this zone would be complex and costly and would result in further problems with regard to the seal.

Another type of proposed solution is that of subjecting the pipe to a prestressing process called “autofrettage”. This known process, however, is effective only with regard to stresses due to the action of the pulsating pressure of the fluid, but not with regard to the axial stresses due to the vibrations. Moreover, said method is not easily controllable and repeatable with constant results.

There therefore exists the need to provide a pipe of a new type which, by means of simple and low-cost measures, is able to overcome all the abovementioned drawbacks and ensure efficient sealing of the fluid with good resistance to the various types of stress.

### BRIEF SUMMARY OF THE INVENTION

The invention achieves the abovementioned objects by means of a pipe of the type described initially, in which the internal surface and/or external surface are treated so as to obtain an increase in the hardness and/or the mechanical strength of the pipe, with regard to both radial and tangential stresses and axial stresses. In fact, as will be explained with greater detail in the description of the accompanying drawings, it has been found that, in particular in the case of pipes with a high coefficient K, i.e. a high ratio between external diameter and internal diameter, as in the present case, the stress due to the internal pulsating pressure is considerable only in the region of the surface layers close to the internal wall and is drastically reduced in the case of small depths. In other words, the action of the pressure is maximum in the region of the internal wall of the pipe and the immediately adjacent layers and diminishes in a hyperbolic or exponential manner, i.e. very rapidly, so as to tend towards a low value which is substantially constant or even towards zero in the outwards direction. It may therefore be stated, as a good approximation, that the stress due to the pulsating pressure of the fluid has a substantially superficial effect, so that the treatment of strengthening the internal wall of the pipe is sufficient to counteract effectively the action thereof.

Similarly, as will be described in greater detail in the illustration shown in the accompanying drawings,. it has been found that the axial stressing action, i.e. flexing of the pipe due to the vibrations, has its maximum intensity in the region of the external surface and the immediately adjacent layers and also diminishes rapidly, albeit in a substantially linear manner, towards the inside. It may therefore be stated, with a good degree of certainty, that the axial stressing effect is mainly superficial and that a treatment for strengthening the external wall of the pipe is sufficient to counteract effectively the action thereof.

With reference to the general characteristics of the pipe, the latter may be made from one material or several materials (multiple-layer), in particular metal, and a more particularly carbon steel, steels produced by nitriding (alloyed steels) or the like.

The dimension of the thickness of the pipe wall may be much greater than the dimension of the bore diameter, namely the pipe may have an external diameter much greater than the internal diameter.

The internal diameter of the pipe, namely the diameter of the bore, may be very small and in particular in the region of between 1 and 3 millimeters.

With reference to the abovementioned problems relating to the effects of the various stresses, at least the external surface may be subjected to a nitriding or carbonitriding treatment or at least the internal surface may be subjected to a nitriding or carbonitriding treatment.

Advantageously, for the abovementioned reasons, both the surfaces, i.e. internal surface and external surface, may be subjected to a nitriding or carbonitriding treatment.

Surprisingly this method may be effectively applied also to the internal surface of the pipe, something which—in view of the small internal diameter of the pipe—was not considered possible by persons skilled in the art. Therefore, the invention shows that, with particular measures, it is possible to subject also the internal wall of the pipe to a strengthening treatment.

The present invention is based on the recognition of the real technical problem and the mechanism underlying the breakages or leakages caused in the fuel feed pipes. In fact, the reasons for which these breakages occur are clearly defined, formulated and expressed, thus allowing the person skilled in the art to have a clear view of the situation and undertake the appropriate technical measures for the solution. The action and the stresses of the radial/tangential and axial effects—which are confined to the surface area of the pipe wall cross-section—being known, the present invention is based on the fact that it is possible to remedy both the breakages due to axial stress and the breakages due to radial/tangential stress, namely the breakages due to the vibrations and the breakages due to the internal pulsating pressure, by means of a single strengthening treatment which has a substantially superficial effect and can also be carried out on the internal wall of the pipe, despite the very small diameter of the bore.

Nitriding or carbonitriding cause a hardening or prestressing of the surface layers of the material, i.e. produce permanent compressive stresses which oppose the dynamic stresses due to the pulsating pressure and to the vibrations, resulting in a general increase in the fatigue resistance. Said treatments allow a reduction in the machining time and costs and ensure total reliability. Nitriding and carbonitriding are able to ensure good modulation of the effect thereof and precise calibration. By varying the pressure and the various parameters, in fact, it is possible to obtain constant and repeatable results which are controllable, in particular with regard to the depth of penetration of the treatment into the material of the pipe. Said treatments are low-cost. They allow complete treatment of all the pipe surfaces, including the internal surface and external surface of the shaped front ends, independently of their shape. In particular for these shaped parts, the conventional lining treatment cannot be applied in a low-cost and simple manner, while the methods according to the invention are effective and may be applied in a low-cost manner so as to increase at least the strength of at least the superficial layers—as is required and sufficient in order to solve the problem—to values comparable with those of the other components of a high-pressure system. Moreover, the experimental data available indicate that the microscopic cracks in the treated materials are less dangerous, so that the nitriding or carbonitriding treatment has the further effect of lessening the concentration of force associated with the microscopic machining cracks or flaws which may be present in the internal wall of the pipe. This latter characteristic plays a decisive part in increasing the strength properties of the pipes wall, in particular with regard to radial and tangential stresses, thus also correcting manufacturing anomalies resulting from drawing.

Both nitriding and carbonitriding improve the aesthetic appearance of the treated material, providing the latter with an attractive homogeneous chromatic tone. This factor may also have a positive psychological effect on the purchaser, for example of a motor vehicle, who may form a positive opinion as to the quality of a product, in particular a motor car, taking into consideration also the aesthetic appearance of the engine or its parts. An aesthetically well looked-after appearance of these parts also offers an image of constructional precision and cleanliness and hence operational reliability of the mechanical parts.

The nitriding or carbonitriding treatment ensures excellent resistance to wear, fatigue and corrosion, does not cause deformation and, owing to the high repeatability thereof, may be applied to finished parts, reducing machining cycles and production costs.

Advantageously, the nitriding or carbonitriding treatment may envisage cycles for increasing or lowering in a pulsed manner the pressure of the controlled nitrogen or carbon and nitrogen atmosphere. In other words, the pressure of the nitriding atmosphere is cyclically increased for a certain period of time and then allowed to drop to a lower level for a further period of time. This measure facilitates penetration of the gas into the pipe bore, despite its small diameter, and helps in the treatment of the internal surface of the said pipe.

In combination with the nitriding or carbonitriding treatment it is possible to envisage the step of subjecting the pipe to a prestressing process, in particular the aforementioned “autofrettage” process.

In fact, nitriding or carbonitriding produce prestressing in the surface layers. This has an effect similar to that obtained with the “autofrettage” treatment, but nevertheless may be combined therewith. In this case, a dual modulation of the effect may be obtained by modifying the main parameters of the two processes, such as the autofrettage pressure and the nitriding depth.

The pipe according to the present invention may form a tubular element or a part of a pulsating pressurised-fluid feed system having a number of functions greater than that of merely conveying fluid, such as, for example, a manifold element or the like, in particular a manifold used in so-called “common rail” feed systems for diesel engines. The underlying principle according to the present invention may also be advantageously applied in tubular elements of this type.

Obviously, in combination with the internal and/or external surface treatment of the pipe, it is possible to envisage also the autofrettage treatment, and/or in combination with at least one of these methods of treatment, the application of one or more lining layers consisting of different materials, such as internal or external sheaths of metallic or non-metallic material or the deposition of layers of material.

The present invention also relates to a method for manufacturing a pipe or a tubular element of the type described hitherto. Said method may comprise the following steps:

drawing of the pipe;

all the machining operations, from cutting in the unfolded condition to shaping of the individual pipes;

carrying out of an internal and/or external surface treatment so as to obtain an increase in the hardness and/or mechanical strength of the pipe, with regard to both the radial stresses and the axial stresses.

The method may envisage that at least the internal surface of the pipe is subjected to a nitriding or carbonitriding treatment or that at least the external surface of the pipe is subjected to a nitriding or carbonitriding treatment.

Advantageously, both the surfaces, i.e. internal surface and external surface, may be subjected to a nitriding or carbonitriding treatment.

Said treatment may also be extended to the internal surface and/or external surface of the front ends of the pipe.

The nitriding or carbonitriding process may envisage cycles for increasing and lowering in a pulsed manner the pressure of the controlled nitrogen or carbon and nitrogen atmosphere.

The nitriding or carbonitriding process may be combined with a treatment for prestressing the pipe, for example such as a further step involving a pipe already subjected to treatment of another type, in particular the process called “autofrettage”.

The method according to the present invention may be advantageously applied to a pipe which forms a tubular element or a part of a system having a number of functions greater than that of merely conveying fluid, such as for example a manifold element or the like, in particular a manifold for so-called “common rail” feed systems for diesel engines.

In combination with the internal and/or external surface treatment step, it is possible to envisage steps involving internal and/or external lining of the pipe with one or more layers of metallic or non-metallic material or with combinations of metallic and non-metallic layers. These layers may be applied both before and after the nitriding or carbonitriding process, i.e. may also be subjected or not to the abovementioned processes both during application to the pipe and separately.

The advantages of the present invention are obvious from that illustrated above and consist above all in the fact of being able to obtain, in a simple and low-cost manner, a pressurised-fluid feed pipe which is able to withstand effectively high pulsating pressures, with intense radial/tangential stresses, and which is able to resist strong vibrations, with significant axial stressing. The invention overcomes a technical prejudice regarding the possibility of subjecting the internal wall of the pipe to nitriding, despite the small diameter of the bore. Moreover, the invention shows how the method forming the subject thereof produces other positive and advantageous effects such as, in particular, a lessening in the effect of the microscopic cracks and an improvement in the aesthetic appearance of the pipe.

The further characteristic features and any improvements of the invention form the subject of the subsidiary claims.

The characteristic features of the invention and the advantages arising therefrom will emerge more clearly from the following detailed description of the accompanying figures, in which:

### BRIEF DESCRIPTION OF THE SEVERAL VIEWS OF THE DRAWINGS

FIG. 1 shows the progression of the intensity of the radial/tangential stresses acting on the pipe wall; and

FIG. 2 shows the progression of the intensity of the axial stress acting on the pipe wall.

### BEST MODE FOR CARRYING OUT THE INVENTION

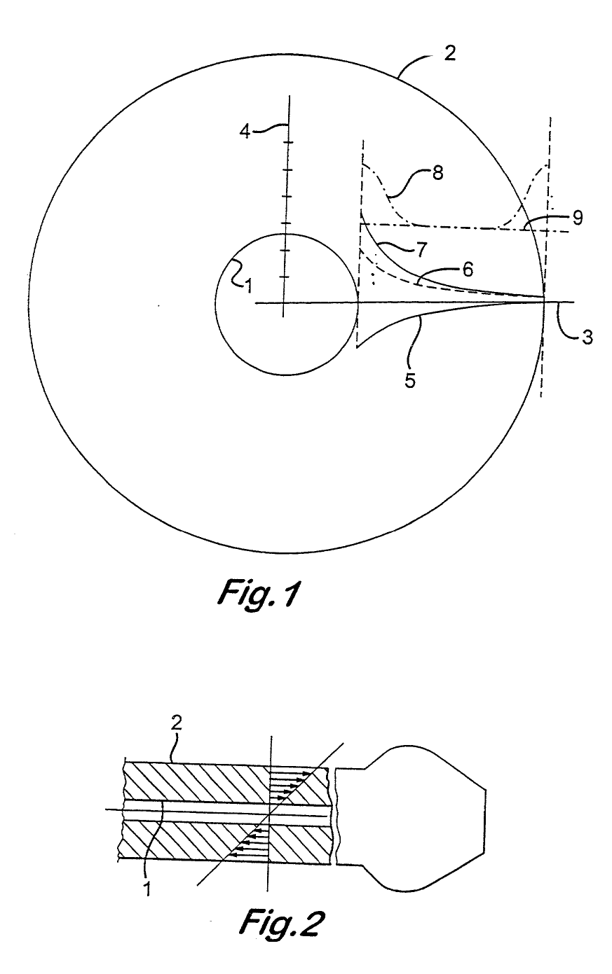

With reference to FIG. 1, 1 denotes the internal wall of the pipe, while the number 2 denotes the external wall. The values of the pipe radius are shown on the abscissa axis 3, which is marked along the diameter of the pipe, the value 0 corresponding to the centre of the latter, i.e. its axis. The values relating to the stress intensity are shown on the ordinate axis 4. The pressure of the fluid creates a radial stress, represented by the curve indicated by the number 5, and a tangential stress represented by the curve indicated by the number 6. The effect of the pressure of the fluid on the material of the pipe is due substantially to a non-equivalent, non-balanced anisotropic response of the radial stress 5 and the tangential stress 6. The stress which acts on the material is determined both by the stress 5 and by the stress 6; the equivalent “Von Mises” stress is represented by the curve 7. As can be seen from the graph, said yield stress 7 has its maximum intensity on the internal surface 1 of the pipe, while it drops abruptly 9 towards the outside, namely in the region of the deepest layers, tending towards a very low substantially constant value. This fact gives rise to the conclusion that the action of the fluid pressure is considerable only on the internal surface 1 of the pipe and the immediately adjacent layers, so that the strengthening and prestressing treatment described above is recommended.

The curve indicated by the number 8 indicates the qualitative progression of the strength and the hardness of the material after nitriding or carbonitriding, namely or analogously the maximum stressing capacity of the pipe in relation to the maximum yield stress which it is able to withstand after treatment. As can be seen, the mechanical strength and the hardness of the material are drastically increased compared to the progression prior to treatment (curve 9). By suitably calibrating the treatment parameters it is possible to obtain an increase in the hardness/strength such as to overcome the yield stress at the currently required levels (curve 7). The progression of the curve 8 is similar to that of the curve 7 in the zone of the internal diameter, i.e. the increase in strength is proportional to the increase in the stresses. In FIG. 1 the axial stressing effect is not visible since it is a force, the direction of which is perpendicular to the sheet of the drawing.

With reference to FIG. 2, the progression in the flexing stress is shown schematically in a longitudinally sectioned view of the pipe. As can be clearly seen, the greater effect of the flexing stress is evident in the region of the outermost layers and reaches its maximum level on the external surface 2. This conclusion forms the basis for the validity of the present invention, namely the fact of having recognized that it is sufficient to subject to the nitriding or carbonitriding treatment on both of the pipes surfaces, that is a pipe to the external surface as well as the internal surface, in order to increase the hardness and mechanical strength characteristics thereof with regard to both the pulsating pressure and the vibrations. With reference to FIG. 2, the curve analogous to that 8 in FIG. 1 is not shown therein, so to avoid making the figure incomprehensible.

All the considerations arising from the illustration of the drawings are also valid in relation to other tubular elements of feed systems for diesel engines and in particular for the manifolds of so-called “common rail” systems. In this case also solely the nitriding treatment of the internal and external walls is sufficient to increase in a satisfactory manner the hardness and mechanical strength characteristics thereof.

Clearly, the invention is not understood as being limited to the type of pipe described, but may be advantageously applied to other types of pipes, for example of the multiple-layer type. Moreover, the invention is not to be regarded as limited to the sector of diesel engines, but may also advantageously be applied in any sector where the same problems facing and solved by the present invention exist. All of this without departing from the underlying principle indicated above and claimed below.

1. A pipe for pressurised-fluid feed systems, in particular for feeding fuel in diesel engines or the like, comprising a wall of predetermined thickness with an internal surface (1) and an external surface (2) and an internal bore with a predetermined diameter for through-flow of the fluid, characterized in that the internal surface and/or external surface are treated by means of nitriding and/or carbonitriding so as to obtain an increase in the hardness and/or mechanical strength of the pipe, with regard to both radial and tangential stresses and axial stresses.

2. A pipe according to claim 1, wherein said pipe is made from metals, steels, alloyed steels produced by nitriding and/or multiple-wall pipes with a stronger internal core.

3. A pipe according to claims 1 and 2, wherein the dimension of the thickness of the wall is much greater than the dimension of the bore diameter, i.e. the pipe has an external diameter much greater than the internal diameter.

4. A pipe according to claim 1, wherein the internal diameter of the pipe, namely the diameter of the bore, is very small and in particular in the region of between one and three millimeters.

5. A pipe according to claim 1, wherein at least the external surface is subjected to a nitriding or carbonitriding treatment.

6. A pipe according to claim 1, wherein at least the internal surface is subjected to a nitriding or carbonitriding treatment.

7. A pipe according to claim 1, wherein both the surfaces, i.e. internal surface and external surface, are subjected to a nitriding or carbonitriding treatment.

8. A pipe according to claim 1, wherein the nitriding or carbonitriding treatment envisages cycles for increasing or lowering in a pulsed manner the pressure of the controlled nitrogen or carbon and nitrogen atmosphere.

9. A pipe according to claim 1, wherein in combination with the nitriding or carbonitriding treatment, the step of subjecting the said pipe to a prestressing process, in particular the process called “autofrettage”, is envisaged.

10. A pipe according to claim 1, wherein at least one front end shaped for sealed connection and in that the nitriding or carbonitriding treatment is also extended to at least part of the internal surface and/or external surface of the front ends of the pipe.

11. A pipe according to claim 1, wherein said pipe forms a tubular element or a part of a pressurised-fluid feed system having a number of functions greater than that of merely conveying fluid, such as, for example, a manifold element or the like, in particular a manifold used in so-called “common rail” feed systems for diesel engines.

12. A pipe according to claim 1, wherein said pipe has one or more external and/or internal lining layers which are subjected either at least together or separately to a single-face or dual-face strengthening treatment by means of nitriding and/or carbonitriding.

13. A method of manufacturing a pipe or a tubular element, characterized by the steps of
drawing of the pipe;
all the machining operations, from cutting in the unfolded condition to shaping of the individual pipes; and
the carrying out of an internal and/or external surface treatment so as to obtain an increase in the hardness and/or mechanical strength of the pipe, with regard to both radial/tangential stresses and axial stresses.

14. A method according to claim 13, wherein at least the internal surface of the pipe is subjected to a nitriding or carbonitriding treatment.

15. A method according to claim 13, wherein at least the external surface of the pipe is subjected to a nitriding or carbonitriding treatment.

16. A method according to claim 13, wherein both the surfaces, i.e. internal surface and external surface, of the pipe are subjected to a nitriding or carbonitriding treatment.

17. A method according to claim 13, wherein the nitriding or carbonitriding treatment is also extended to at least part of the internal and/or external surfaces of the front ends of the pipe by means of screening of the parts not to be treated.

18. A method according to claim 13, wherein the nitriding or carbonitriding step envisages cycles for increasing or lowering in a pulsed manner the pressure of the controlled nitrogen or carbon and nitrogen atmosphere.

19. A method according to claim 13, wherein in combination with at least one preceding and/or with at least one subsequent step, an additional step consisting of subjecting the pipe to a prestressing process.

20. A method according to claim 13, applied to a pipe which forms a tubular element or a system part having a number of functions greater than that of merely conveying fluid, such as, for example, a manifold element or the like, in particular a manifold for so-called “common rail” feed systems for diesel engines, is envisaged.

21. A method according to claim 13, comprising one or more steps for internally and/or externally lining the pipe prior to or after surface treatment thereof and/or one or more steps for separate or simultaneous surface treatment of the internal and/or external lining layer(s) of the pipe.

22. A method according to claim 13, comprising a surface oxidation step intended to provide an attractive aesthetic appearance and high corrosion resistance.
